(19) United States
(12) Patent Application Publication
(10) Pub. No.: US 2011/0113939 A1
(43) Pub. Date: May 19, 2011

(54) MACHINE TOOL

(76) Inventor: Stephan Simon, Sibbesse (DE)

(21) Appl. No.: 12/736,821

(22) PCT Filed: Dec. 16, 2008
(86) PCT No.: PCT/EP2008/067638

§ 371 Date: Jan. 31, 2011

(30) Foreign Application Priority Data
May 13, 2008 (DE) 10 2008 001 727.2

(51) Int. Cl. B26D 1/00; B26D 5/08; B26D 5/00

(52) U.S. Cl. 83/13; 83/563; 83/360; 83/367

(57) ABSTRACT

A machine tool, in particular a circular table saw, having a tool holding fixture, in particular for a disk-shaped, rotary-drivable tool, and a protective device. The protective device may be provided for the purpose of guiding the tool into a safety position, and from the safety position into at least one working position.

### FIELD OF THE INVENTION

The present invention is directed to a machine tool.

### BACKGROUND INFORMATION

A machine tool having a tool holding fixture for a disk-shaped, rotary-drivable tool and a protective device is already known.

### SUMMARY OF THE INVENTION

The exemplary embodiments and/or exemplary methods of the present invention is directed to a machine tool, in particular a circular table saw, having a tool holding fixture, in particular for a disk-shaped, rotary-drivable tool, and a protective device.

It is proposed that the protective device be provided for the purpose of guiding the tool into a safety position, and from the safety position into at least one working position. In this connection, “provided” is to be understood to mean in particular specifically equipped and/or specifically designed and/or specifically programmed. Furthermore, “safety position” is to be understood to mean in particular a position of the tool, in particular of a saw blade, in which the tool cannot come into contact with either the workpiece or with an operator of the machine tool, in particular unintentionally. The protective device may be utilized or positioned advantageously with all machine tools having a separating, cutting and/or which may be sawing tool. Because of its protective properties, the protective device is particularly advantageous on a circular table saw.

The protective device may be constituted of a device that is provided for the purpose of guiding, in particular moving, the tool into the safety position. Due to the configuration according to the exemplary embodiments and/or exemplary methods of the present invention, it is possible to achieve protection, in particular of the operator, from the tool, in particular during operation of the machine tool, in that the tool may be guided by the safety device into the safety position, in particular in a danger situation for the operator. Guiding of the tool to the safety position by the protective device may take place at least partially automatically, and particularly advantageously, fully automatically, the protective device having a control unit for this purpose.

It is further proposed that the machine tool has a basic unit and the protective device, which is provided for the purpose of positioning the tool in a fully retracted safety position within the basic unit when not in operation and/or in a danger situation. In this case, “not in operation” is to be understood in particular to mean that a motor unit of the machine tool, which is provided in particular for a rotary drive of the machine tool, is in a switched-off state and/or in an inactive state, and/or that the tool is in a switched-off state and/or in an inactive state, and/or that the tool is in an active state but that no sawing, separating, cutting, etc., is taking place, and/or that an object or workpiece to be worked on is situated outside of a monitored area around the tool.

A “danger situation” is to be understood in particular to mean a situation that represents a danger, in particular a danger of injury, in particular by the tool, for an operator of the machine tool, for example when guiding an object to be worked on, in that a hand of the operator may be present or located in too close proximity to the tool, in particular within a danger zone. Furthermore, a “basic unit” is to be understood to mean a unit which is situated at least partially around the tool during operation of the tool or of the machine tool, and/or which may be situated fixedly on the machine tool, in particular non-detachably for the operator of the machine tool, and/or is a fixed element of the machine tool. The basic unit may be constituted in this case by a work table of a circular table saw. In principle, designing the basic unit from other components and/or elements that appear reasonable to those skilled in the art, such as a housing of a hand-held circular saw, etc., is always conceivable.

Furthermore, a “fully retracted safety position within the basic unit” is to be understood in particular to mean a position of the tool in which the tool may be situated with at least 80% of the total height of the machine tool within the basic unit, particularly advantageously with at least 90% situated within the basic unit, and particularly may be with 100% of the total height completely situated within the basic unit at a distance from a surface of the basic unit, so that the tool which may be completely shielded from an operator for safety reasons.

In the completely retracted safety position within the basic unit, the tool may be situated in such a way that it is shielded from unintentional contact with the operator by an additional protective element such as a protective flap. The design according to the exemplary embodiments and/or exemplary methods of the present invention makes it possible to advantageously minimize a risk of injury by the tool for an operator, and cleaning of a working surface of the basic unit, in particular a surface of a work table facing the operator, is achievable for the operator without a risk of injury, in particular from an unintentional contact of the operator with the tool, due to the completely retracted safety position of the tool within the basic unit.

It is also proposed that the protective device has a first sensor unit, which is provided for the purpose of differentiating a workpiece from a moving object, whereby a danger situation, in particular for an operator of the machine tool, may be recognized advantageously. After the danger situation has been detected it will be possible for the protective device to initiate protective functions to protect the operator. In this case, a “moving object” is to be understood in particular to mean a non-rigid object, such as a hand of the operator, it being necessary for the object to execute a motion for a differentiation. Alternatively, it is additionally also conceivable for the sensor unit to have, for example, a sensor element for detecting a surface structure of skin, and/or some other sensor element that appears reasonable to those skilled in the art.

An advantageous adaptation of the tool to the workpiece to be processed, in particular a cutting height of the tool extending out of the basic unit, may be achieved if the first sensor unit is provided for sensing a characteristic of a height of a workpiece. In this connection, a “height of a workpiece” is to be understood in particular to mean an extension of the workpiece in a direction that is oriented essentially perpendicularly to a main extension surface of the basic unit, in particular to a guiding surface for guiding the workpiece, and which extends from the guiding surface of the basic unit to a surface of the workpiece that faces away from the guiding surface. The characteristic of the height of the workpiece may be ascertained using triangulation measurement and/or laser telemetry, LIDAR measurement, light propagation time measurement and/or some other measuring method that appears reasonable to those skilled in the art, it being possible to detect the characteristic of the height based on a distance of a workpiece surface from the sensor unit and to ascertain the height of the workpiece therefrom.

It is also proposed that the first sensor unit senses the characteristic of the height at least two different positions, whereby it is possible to distinguish a rigid object, in particular the workpiece, from a non-rigid object, in particular a moving object. The two different positions for sensing the characteristic of the height may be situated sequentially along a cutting line, or along a line parallel to the cutting line and close to the cutting line. It is possible here to advantageously ascertain a profile of the workpiece and/or of the moving object at two different positions, and thereby to detect a motion of a moving object with respect to a rigid object, in particular the workpiece. The first sensor unit may have at least one sensor element that detects the characteristic at the two different positions, for example a camera, in particular a line scan camera, which is able to detect signals from one or more light sources, for example laser light sources or a light source whose signal is divided. However, two different sensor elements for detecting the characteristic of the height at the two different positions are also always conceivable, for example an infrared sensor, a radar sensor, etc.

A simple arrangement, particularly in terms of design, which also provides effective sensing prior to a possible contact of the workpiece and/or a moving object with the tool, in particular with a saw edge of the tool, may be achieved if the first sensor unit has at least one sensor element which is positioned at least partially along a feed direction of an object ahead of the tool. In this connection, a “feed direction of an object” is to be understood in particular to mean a direction that may extend from an edge area of the basic unit along a main extension surface of the basic unit and parallel to a main extension surface of the tool, and into which the object is pushed for processing by the operator of the machine tool, along a guide surface of the basic unit formed by the main extension surface.

In another embodiment of the present invention it is proposed that the protective device has a second sensor unit, which is provided for the purpose of determining a characteristic of a travel distance of an object.

Due to the configuration of the exemplary embodiments and/or exemplary methods of the present invention, an advance of the tool out of the basic unit and/or a drive of the tool may be adjusted advantageously to a travel distance of the object constituted by a feed distance, in particular of the workpiece, and/or to a length of the object. The feed may be measured continuously. In addition to sensing the characteristic of the travel distance, advantageous sensing of a direction in which the object is moved toward the tool may also be determined, and in the event of a non-zero motion component of the object which is directed perpendicularly to the correct feed direction and hence perpendicularly to a main extension surface of the tool, the tool may remain in the fully retracted safety position inside the basic unit. This makes it possible to prevent unwanted canting of the object against the tool, and thus at least to reduce a danger of injury for the operator due to deflection of the object. The sensor unit for detecting the characteristic of the travel distance may be constituted here of an optomechanical sensor unit, a purely optical sensor unit which may be with LED and/or laser sensor elements, and/or other sensor units that appear reasonable to those skilled in the art.

Particularly advantageously, the second sensor unit is situated at least partially inside the basic unit, so that a particularly compact and space-saving arrangement of the second sensor unit inside the machine tool is achievable. In addition, the second sensor unit may be protected thereby from unwanted soiling and/or unwanted wear.

It is further proposed that the second sensor unit has at least one sensor element that is situated along a feed direction of an object, at least partially ahead of the tool, whereby a characteristic of a travel distance and possibly of a direction of the object may be sensed particularly advantageously, and thus an advance of the tool into a working position may be adjusted to the distance traveled by the workpiece. This may be achieved particularly advantageously and in particular economically, if the sensor element operates according to a principle such as that widely used in conventional computer mice. In addition, a possible danger for the operator may also be detected early, for example, one or both hands of the operator slipping off the workpiece, which are moving toward the tool at high speed, so that a risk of injury and/or a severity of an injury for the operator may be at least partially reduced.

It is further proposed that the second sensor unit has an additional sensor element, which is situated along a feed direction of an object at least partially beside the tool, whereby a drive of the tool or an advance of the tool into a cutting position may be adapted advantageously to a most exact possible position of the workpiece. An increased number of sensor elements and/or a placement of the sensor elements in an area around the tool may at least partially prevent unwanted sensing gaps, and safety for the operator may be advantageously increased thereby. Here, “beside the tool” is to be understood in particular to mean that the sensor element is situated in a position at the smallest possible distance from the tool, which is oriented essentially perpendicularly to a main extension surface of the tool.

In an advantageous refinement of the exemplary embodiments and/or exemplary methods of the present invention it is proposed that the protective device has an actuator unit, which is provided for the purpose of moving the tool essentially along a plane of the tool. Here a “plane of the tool” is to be understood in particular to mean a main extension surface of the tool, in particular a sawing tool. “Essentially along a plane of the tool” is to be understood here in particular to mean an orientation or a direction of motion that encloses an angle to the plane of the tool that may have a maximum value of 15°, which may be a maximum of 8°, and particularly advantageously a maximum of 3°, so that the tool may also be pulled away obliquely when retracting the tool.

Furthermore, a “motion of the tool” is to be understood in particular to mean a motion that is provided for the purpose of adjusting a cutting height of the tool. The motion of the tool may be constituted here of a linear motion, and/or particularly advantageously of a rotary motion around an axis perpendicular to the plane of a saw blade. Due to the configuration according to the exemplary embodiments and/or exemplary methods of the present invention, a height or a cutting height of the tool, in particular a height or cutting height projecting out of the basic unit, may be advantageously adjusted, and rapid retraction of the tool is achievable in a danger situation for the operator.

It is further proposed that the actuator unit be provided for the purpose of adapting a cutting height of the tool to the characteristic of the height of the workpiece, whereby it is advantageously possible to achieve precise working, in particular precise cutting, of the workpiece. For precise working, in particular sawing, a cutting height of the tool may be set that is higher than the height of the workpiece by approximately the height of one saw tooth of the tool, or by approximately 0.5 cm. In addition, a possible contact surface of the tool extending out of the workpiece may be reduced by, for example, one hand of the operator, and a danger of injury and/or a severity of the injury for the operator may be at least reduced thereby. The adjustment of the tool height or the setting of the tool height may take place in this case continuously and which may be automatically by a control unit of the machine tool, or may be set manually by an operator of the machine tool.

Particularly advantageously, the actuator unit has a motor unit, which may be used to achieve a particularly quick adjustment of the cutting height of the tool. In addition, retraction of the tool by the motor unit into a completely retracted safety position inside the basic unit may be constituted by a reversible process in a danger situation and/or when not in operation.

It is further proposed that the protective device has a control unit. In this connection, “control unit” is to be understood in particular to mean a unit that may be constituted of a computing unit, an evaluation unit, a monitoring unit and/or a regulating unit, it being possible for the control unit to be constituted either of a processor alone or in particular of a processor and other electronic components, such as a memory arrangement to structure. The control unit may be used to achieve advantageous rapid data evaluation of the data sensed by the first sensor unit and/or the second sensor unit. In addition, particularly advantageously, a safety query may take place in the control unit before the tool is advanced into a working position, thereby advantageously preventing the tool from advancing in a danger situation.

It is further proposed that the control unit be provided for the purpose of adapting power and/or rotational speed to at least one characteristic sensed by the first and/or the second sensor unit, whereby a sawing operation may be adapted advantageously to a material height and/or a feed distance and/or a feed velocity. The feed velocity may be ascertained by derivation according to the time of the feed distance. For example, at a low feed velocity, due to an assumption in the control unit that a sensitive, easily damaged material may be present, the rotational speed of the motor unit and/or the drive torque of the tool may be reduced or adapted to the sensitive, easily damaged material.

In addition, the control unit may be provided advantageously for the purpose of changing an operating mode of the motor unit on the basis of a sensed, moving object, whereby in an acute danger situation, in particular for the operator of the machine tool, advantageous protection may be achieved by reducing, and particularly advantageously by switching off, the motor unit. In particular, especially rapid slowing of the rotational speed of the motor unit is achievable, for example, by electrical short circuiting of the motor unit.

Particularly advantageously, an emergency braking mechanism may be activated by the control unit, in particular for the tool, thereby achieving advantageous protection for the operator. The emergency braking mechanism may be activated only when there is acute danger of injury to the operator, for example by a hand sliding off the workpiece at a slight distance from the tool, so that rapid triggering of the protective function within a few milliseconds should occur, so that in this case an emergency braking mechanism is able to protect the operator from a possible injury or the severity of an injury may be reduced. This emergency braking mechanism may have an emergency brake that is constituted of an eddy-current brake, of brake pads that effect a retardation through mechanical friction, and/or may be constituted of other emergency braking devices that appear reasonable to those skilled in the art.

Additional advantages arise from the following drawing description. The drawing depicts exemplary embodiments of the present invention. The drawing, the description and the claims contain numerous combinations of features. It will be useful for those skilled in the art to also consider the features individually and combine them into other sensible combinations.

### BRIEF DESCRIPTION OF THE DRAWINGS

FIG. 1 shows a schematic depiction of a machine tool constituted of a circular table saw having a protective device.

FIG. 2 shows a schematic depiction of an adjustment of a tool height to data sensed by at least one first sensor unit.

FIG. 3 shows a diagram of a pattern of the data sensed by the first sensor unit.

FIG. 4 shows a schematic depiction of a block diagram of the protective device having a control unit.

FIG. 5 shows a schematic depiction of the protective device in an alternative design to FIG. 1.

### DETAILED DESCRIPTION

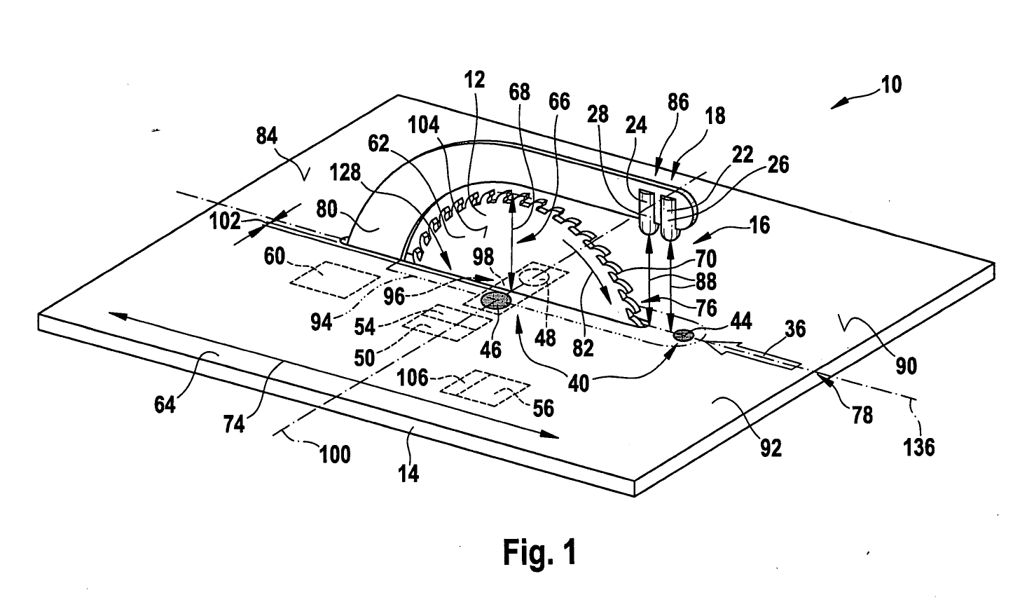

FIG. 1 depicts a machine tool 10 constituted of a circular table saw. Machine tool 10 includes a tool holding fixture 128 for a disk-shaped, rotary-drivable tool 12 constituted of a circular saw blade 62, a basic unit 14 constituted of a work table, and a protective device 16, which is provided for the purpose of protecting an operator from injuries during operation of machine tool 10. In addition, protective device 16 is provided for the purpose of guiding tool 12 into a safety position, and from the safety position into at least one working position. To this end, protective device 16 assigns tool 12 to a completely retracted safety position within work table 64 during non-operation of tool 12 or during non-operation of machine tool 10 and/or in a danger situation. Tool 12 is also situated in the completely retracted safety position within work table 64 in a switched-off state of machine tool 10 or in a switched-off state of motor unit 60, which is provided for the purpose of producing a drive torque for tool 12. In addition, tool 12 is situated in the completely retracted safety position within work table 64 if no workpiece 20 is in proximity to tool 12 on work table 64 for processing, it being possible in this case for tool 12 to be driven by motor unit 60 at idle speed, and/or if a danger situation for the operator exists. A section 66 of tool 12 projects out of work table 64 exclusively for sawing workpiece 20. Protective device 16 has a first sensor unit 18, a second sensor unit 40, an actuator unit 50 and a control unit 56.

Actuator unit 50 is provided for the purpose of moving tool 12, situated in tool holding fixture 128, the motion being essentially along a plane of tool 12 for adjusting the height of tool 12. To this end, actuator unit 50 has a motor unit 54 constituted of a servomotor, with the aid of which a continuous height adjustment of tool 12 is achieved. The height adjustment of tool 12 sets a cutting height of tool 12, the cutting height being constituted of a height 68 of a section 66 of tool 12 projecting out of work table 64. The servomotor is controlled and/or regulated by control unit 56.

First sensor unit 18 is provided for the purpose of sensing workpiece 20 or of differentiating between workpiece 20 or an object 38 to be worked on, and a moving object, for example a hand of the operator. First sensor unit 18 has two sensor elements 22, 24, each of which is constituted of a laser sensor 26, 28 for emitting and receiving laser light. Laser sensors 26, 28 are situated along a feed direction 36 of object 38 or of workpiece 20 ahead of tool 12 or a saw edge 70 of tool 12. Feed direction 36 is oriented parallel to a main extension direction 74 of work table 64, feed direction 36 extending from an edge area 78 facing a possible contact area 76 of tool 12 with workpiece 20, in the direction of tool 12.

In addition, laser sensors 26, 28 are situated sequentially along feed direction 36 on a splitter 80, which is pivotable together with tool 12 around pivot axis 136 of tool 12 and may also be retracted into and advanced out of work table 64 together with tool 12. Splitter 80 extends in a rotational direction 82 of tool 12 partially around the latter, and upon reaching a maximum distance from a surface 84 of work table 64, runs parallel to the latter, opposite feed direction 36. Situated on a front free end area 86 of splitter 80 are the two laser sensors 26, 28, which sense a characteristic for a distance 88 from surface 84 or a characteristic for a height 30 of workpiece 20 using a triangulation measurement principle. Instead of two laser sensors 26, 28, a first sensor unit 18 having only one laser sensor 26 is also conceivable, in which case a split of the laser beam occurs.

Second sensor unit 40 is provided for the purpose of continuous sensing of a characteristic of a travel distance constituted of a feed distance, and of a characteristic of a direction of motion of object 38, which is guided by an operator of machine tool 10 on surface 84 of work table 64 constituted of a guide surface 90. Second sensor unit 40 has three sensor elements 44, 46, 48, each constituted of an optical sensor element 44, 46, 48, which are provided for the purpose of sensing the characteristics of object 38 or workpiece 20. Optical sensor elements 44, 46, 48 work here according to a principle such as that widely used in conventional computer mice. Sensor elements 44, 46, 48 are each situated within work table 64 or basic unit 14, sensor elements 44, 46, 48 each being situated beneath a surface layer of a work surface 92 of work table 64.

A first sensor element 44 of second sensor unit 40 is situated in this case along feed direction 36 of object 38 ahead of tool 12, so that it is possible to sense the travel distance and direction of motion of object 38 or of workpiece 20 or of a hand of the operator prior to a possible contact with tool 12 or with saw edge 70 of tool 12. The other two sensor elements 46, 48 are situated in a danger area 94 next to tool 12 situated around tool 12, in area 96 of a tool suspension mount 98 of tool holding fixture 128 or of an axis of rotation 100 of tool 12, a shortest distance 102 of sensor elements 46, 48 to tool 12 being oriented essentially perpendicularly to a main extension surface 104 of tool 12. When machine tool 10 is in operation, tool 12 rotates around axis of rotation 100.

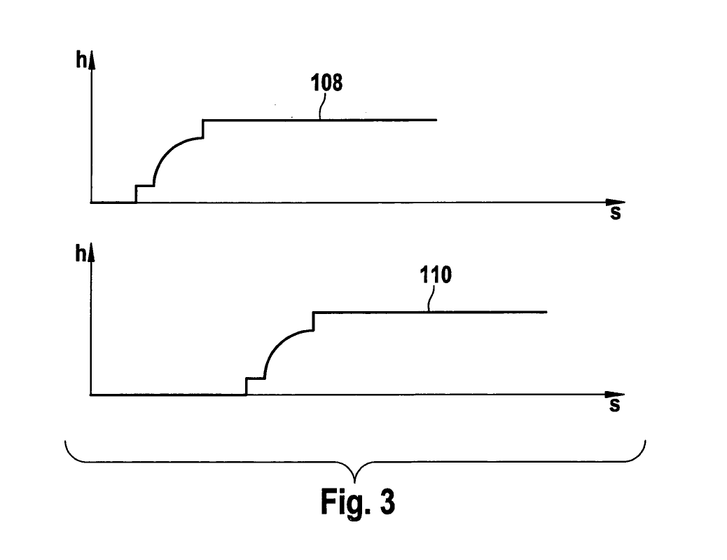

The characteristics detected or sensed by laser sensors 26, 28 of first sensor unit 18 and the three sensor elements 44, 46, 48 of second sensor unit 40 are conveyed via a data line, not shown in further detail, to control unit 56, which is situated where it is well protected beneath work surface 92 of work table 64. Control unit 56 controls a sawing operation of tool 12, which is tied to a previous safety query by control unit 56. In that query, control unit 56 checks whether the conditions for a sawing operation are properly met. These include the correct feed direction, where a directional component perpendicular to the plane of tool 12 must be approximately zero, and a motionlessness of object 38. In this case a signal or profile 110 of laser sensor 28 along the abscissa must be identical to a signal or profile 108 of laser sensor 26, except for a shift and measuring tolerances, and in addition the shift must be equal to an interval of the two laser sensors 26, 28 (FIG. 3).

Here control unit 56 ascertains height 30 of workpiece 20 on the basis of the characteristics sensed by the two laser sensors 26, 28, or distinguishes between a workpiece 20 and a moving, non-rigid object on the basis of the data sensed by the two laser sensors 26, 28. In this case, the characteristics from the two laser sensors 26, 28 are evaluated separately within control unit 56 and compared to each other. Since laser sensors 26, 28 are situated sequentially along the feed direction 36 of object 38, a spatially and temporally shifted or delayed sensing of object 38 along the feed direction 36 by laser sensors 26, 28 occurs.

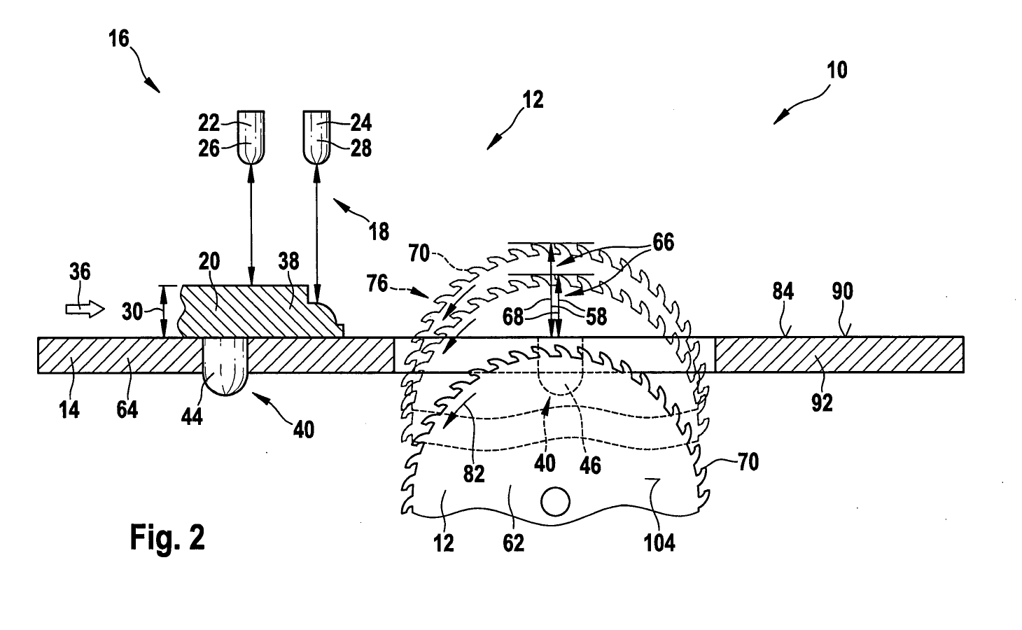

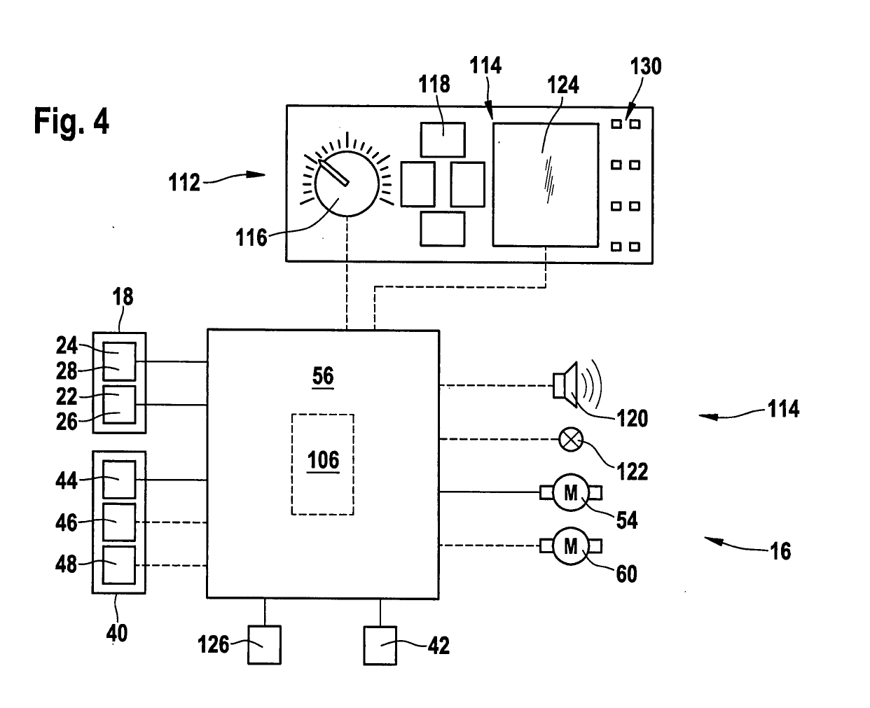

For a comparison of data between two data records from laser sensors 26, 28 in control unit 56, the data records are stored in control unit 56, which has a rewritable memory element 106 for this purpose. If the data records from the two laser sensors 26, 28 have an equivalent profile 108, 110 of height h over travel distance s, but shifted along the abscissa (see FIGS. 2 and 3), this is interpreted in control unit 56 as a rigid workpiece 20 that is being moved toward tool 12 or toward saw edge 70 of tool 12, and tool 12 may be advanced by the servomotor of actuator unit 50 to saw workpiece 20. If motor unit 54 is in an inactive mode, it is activated automatically by control unit 56 to advance tool 12 (FIG. 4).

On the other hand, if the two data records differ in the sensed profile 108, 110, this is interpreted in control unit 56 as a moving object 38 moving toward tool 12, such as a hand of the operator, or that object 38 or workpiece 20 is being moved obliquely toward workpiece 12, which could result in an unintended canting of workpiece 20 against tool 12 during a sawing process and could cause injury to the operator and/or damage to workpiece 20. In both cases, control unit 56 does not activate actuator unit 50 to advance tool 12, and tool 12 remains situated entirely within work table 64 in a safety position.

In addition, height 30 of workpiece 20 is ascertained from sensed profile 108, 110, after which control unit 56 ascertains a required cutting height 58 of tool 12. The currently required cutting height 58 of tool 12 is set by actuator unit 50 or by the servomotor of actuator unit 50, the instantaneous cutting height 58 or a cutting height parameter being conveyed continuously from control unit 56 to actuator unit 50 (FIG. 4). To this end, control unit 56 also evaluates the continuously sensed data from the three sensor elements 44, 46, 48 of second sensor unit 40, which ascertain the feed distance along the proper feed direction and a feed distance in an unwanted direction transverse thereto.

To this end, the data sensed by first sensor element 44 of second sensor unit 40 are evaluated in control unit 56, and on the basis of the ascertained feed distance and stored profiles 108, 110 an instantaneous cutting height 58 projecting from work table 64 is ascertained, matched to the profile of tool 12, and is adjusted continuously by actuator unit 50 or the servomotor during the entire sawing operation; matched to the profile of workpiece 20. Cutting height 58 in this case is higher than height 30 of workpiece 12 by approximately half the height of a saw tooth or approximately 0.5 cm, so that a clean saw cut is achievable during the sawing process.

If an evaluation of the characteristics sensed by sensor elements 44, 46, 48 shows that a workpiece 20 has a non-zero motion component that is oriented perpendicularly to the plane of saw blade 62 or of tool 12, control unit 56 does not activate a sawing operation, since in this case workpiece 20 is being moved obliquely toward tool 12 and could suffer damage in a sawing process. In addition, besides a feed distance of workpiece 20 during a sawing process, an ending of a sawing process is also detected in control unit 56 with the aid of the two additional sensor elements 44, 46 of second sensor unit 40, so that actuator unit 50, controlled by control unit 56, again retracts tool 12 completely into the safety position in work table 64 to protect the operator after the sawing process is ended.

In addition, a currently sensed feed velocity is ascertained in control unit 56 and is compared to reference values stored in control unit 56 or in memory element 106. The feed velocity is determined here in control unit 56 by derivation according to the time of the feed distance. The reference values include a range for the feed velocity of a normal sawing operation. If the sensed feed velocity or velocities is/are greater than a maximum reference value, this is assessed in control unit 56 as a danger situation, for example one or both hands of the operator slipping off while guiding workpiece 20. If tool 12 is still situated in a completely retracted safe position within work table 64, then it continues to remain situated completely within work table 64 to protect the operator.

On the other hand, if tool 12 is already situated in an advanced position for sawing on work table 64, where a section 66 of tool 12 is projecting out of work table 64 perpendicularly to surface 84 of work table 64, a protective function 126 is thereupon activated by control unit 56 (FIG. 4). Activated protective function 126 in this case is dependent on the detected feed velocity, and on a distance or interval of sensed object 38, for example the hand of the operator, from tool 12 or a saw edge 70. In any case, tool 12 is retracted completely into work table 64 by actuator unit 50, controlled by control unit 56. At the same time, to protect the operator and/or other humans, an operating mode of motor unit 60 of machine tool 10 is changed by control unit 56 on the basis of the detected characteristics.

In this case, controlled by control unit 56, a rotational speed or power of motor unit 60 is lowered, or, in the event of an anticipated, immediately impending contact of the operator and/or other humans with tool 12, a stop as fast as possible of motor unit 60 is triggered by control unit 56, for example an intentionally induced electrical short circuit within motor unit 60, and/or an emergency braking mechanism 42 is activated, for example by providing an eddy-current brake for additional braking of rotating tool 12, so that tool 12 is stopped by control unit 56 in the shortest possible time, which may be within a second after the danger situation is detected. In this way, the severity of injuries may be at least partially reduced. After activation of protective function 126 or of emergency brake mechanism 42, machine tool 10 or tool 12 may be reactivated easily, by having a workpiece 20 pushed in front of tool 12 in an area of sensor units 18, 40, and by control unit 56 activating a normal sawing operation of tool 12.

On the other hand, if the currently sensed feed velocity is lower than a minimum reference value of control unit 56 stored in memory element 106, this will be assessed by control unit 56 as a workpiece 20 made of a sensitive material, which is being moved toward tool 12 by the operator. In this case, taking into account the detected height 30 or the detected characteristic of workpiece 20, a rotational speed of motor unit 60 to produce a drive torque for tool 12 and/or a rotational speed of tool 12 is adjusted or reduced by control unit 56. In addition, a rotational speed of tool 12 and/or of motor unit 60, or a current supply for motor unit 60 and/or other parameters, such as a voltage, a pulse width, etc., may be adjusted by control unit 56 on the basis of height 30 and/or the feed velocity or on the basis of the sensed characteristics of workpiece 20. Furthermore, an anticipated sawing performance may be determined by control unit 56 on the basis of a thickness and the feed velocity of workpiece 20 and compared to a power of motor unit 60, the thickness of workpiece 20 to be sawn corresponding in most cases to height 30 of workpiece 20 above the sawing table when tool 12 is oriented perpendicularly to surface 84 of basic unit 14. If the power of motor unit 60 is inadequate here, actuator unit 50 is not activated by control unit 56, and tool 12 remains situated in the retracted safety position within work table 64.

In addition, machine tool 10 or protective device 16 has an input unit 112 and an output unit 114, which are provided for inputting of a parameter by the operator and for conveying information to the operator of machine tool 10. Input unit 112 and output unit 114 are connected to control unit 56 via a data line. The operator may use input unit 112 to adjust cutting height 58 of tool 12. Three different modes for this are available to the operator. In a first mode, cutting height 58 is adjusted automatically by control unit 56, as described above. In a second mode, the operator is able to set a predefined cutting height 58, for example for sawing a groove, which is set automatically by control unit 56. In the second operating mode, the operator is able to choose additionally between a groove depth that is matched to height 30 of workpiece 20 and causes a constant material thickness of the workpiece 20 to be processed to remain, and a constant groove depth, which is independent of height 30 of workpiece 20. In a third mode cutting height 58 is set manually by the operator, lowering or retracting of tool 12 being deactivated here. This may be necessary for example when sawing Plexiglas.

Input unit 114 has four keys 118 for this purpose, for selecting the particular operating mode. In addition, input unit 112 has a control knob 116, by which a setting of a desired cutting height 58 or groove depth may be input by the operator (FIG. 4). Furthermore, the input property of a material of workpiece 20 may be input by an operator via a menu keypad 130 of the input unit, so that a sawing operation may be adapted to a material property in control unit 56.

Output unit 114 has an acoustic output element 120, which is provided for the purpose of advising the operator of a danger situation or of different feedbacks during operation by outputting different signal tones, for example different signal tones when retracting and advancing the tool. In addition, output unit 114 has two visual output elements 122, 124. A first visual output element 122 is constituted of a warning light, which advises the operator of a danger situation. The other visual output element 124 is a display unit constituted of a parameter display, which may inform the operator of a current cutting height 58, or displays for the operator a cutting height 58 or groove depth set by the operator (FIG. 4). In addition, it is also conceivable for vibrations to be generated in a danger situation by a motor winding of motor unit 60, controlled by control unit 56, and to advise the operator of the danger situation.

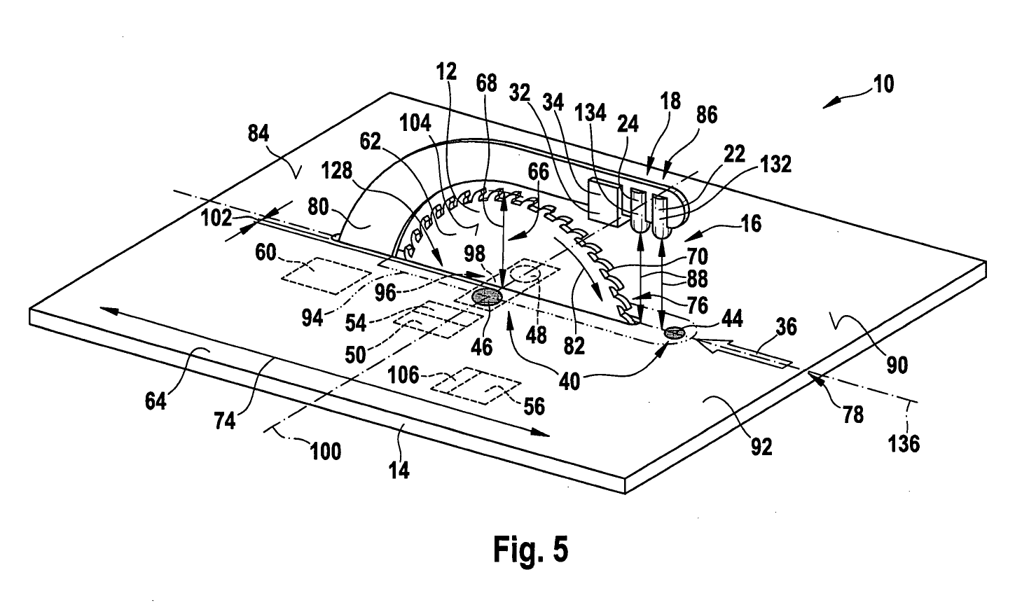

FIG. 5 depicts an alternative exemplary embodiment of a machine tool 10. Essentially equivalent components, features and functions are labeled in principle with the same reference numerals. The following description is limited essentially to the differences from the exemplary embodiment in FIGS. 1 through 4; with regard to equivalent components, features and functions, the reader is referred to the description of the exemplary embodiment in FIGS. 1 through 4.

Machine tool 10 has a tool holding fixture 128 for a tool 12, a basic unit 14 constituted of a work table 64, and a protective device 16. Protective device 16 is provided for the purpose of guiding tool 12 into a safety position and from there into at least one working position, and also to situate tool 12 in a completely retracted safety position within basic unit 14 or work table 64 during non-operation and in a danger situation. Protective device 16 differs from the protective device from FIGS. 1 through 4 in that protective device 16 has a first sensor unit 18 which has, besides two sensor elements 22, 24, each constituted of a laser light source 132, 134, in addition a sensor element 32 constituted of a camera 34. Camera 34 is situated along a feed direction 36 of an object 38 downstream from the two laser light sources 132, 134, on a splitter 80 of machine tool 10. Camera 34, together with the two laser light sources 132, 134, ascertains a characteristic for differentiating a workpiece 20 from a moving object. Furthermore, a characteristic of a height 30 and/or thickness of workpiece 20 is detectable with the aid of camera 34 and laser light sources 132, 134.

1-23. (canceled)

24. A machine tool, comprising:
a tool holding fixture, for a disk-shaped, rotary-drivable tool; and
a protective device for guiding the tool into a safety position and from the safety position into at least one working position.

25. The machine tool of claim 24, further comprising:
a basic unit, wherein the protective device positions the tool in a fully retracted safety position within the basic unit when it is at least one of not in operation and not in a dangerous situation.

26. The machine tool of claim 24, wherein the protective device has a first sensor unit for differentiating a workpiece from a moving object.

27. The machine tool of claim 26, wherein the first sensor unit is for sensing a characteristic of a height of the workpiece.

28. The machine tool of claim 27, wherein the first sensor unit senses the characteristic of the height at least two different positions.

29. The machine tool of claim 26, wherein the first sensor unit has at least one sensor element, which is situated at least partially along a feed direction of an object ahead of the tool.

30. The machine tool of claim 24, wherein the protective device has a second sensor unit for sensing a travel distance of an object.

31. The machine tool of claim 30, wherein the second sensor unit is situated at least partially within the basic unit.

32. The machine tool of claim 30, wherein the second sensor unit has at least one sensor element, which is situated along a feed direction of an object at least partially ahead of the tool.

33. The machine tool of claim 30, wherein the second sensor unit has at least one additional sensor element, which is situated along a feed direction of an object at least partially next to the tool.

34. The machine tool of claim 24, wherein the protective device has an actuator unit for moving the tool essentially along a plane of the tool.

35. The machine tool of claim 27, wherein the actuator unit is for adapting a cutting height of the tool to the characteristic of the height of the workpiece.

36. The machine tool of claim 34, wherein the actuator unit has a motor unit.

37. The machine tool of claim 24, wherein the protective device has a control unit.

38. The machine tool of claim 37, wherein the control unit is for adjusting at least one of a power and a rotational speed to at least one characteristic sensed by at least one of the first sensor unit and the second sensor unit.

39. A method for using a machine tool, the method comprising:
providing a work piece for the machine tool, wherein the machine tool includes a tool holding fixture, for a disk-shaped, rotary-drivable tool, and a protective device for guiding the tool into a safety position and from the safety position into at least one working position, and wherein the machine tool has a first sensor unit; and
differentiating a workpiece from a moving object by using the first sensor unit in the protective device.

40. The method of claim 39, wherein a characteristic of a height of the workpiece is detected.

41. The method of claim 39, wherein a characteristic of a travel distance of the object is detected.

42. The method of claim 39, wherein a cutting height of the tool is set.

43. The method of claim 40, wherein the cutting height of the tool is set with the aid of the detected characteristics of the object.

44. The method of claim 39, wherein a rotational speed is set with the aid of at least one detected characteristic of the workpiece.

45. The method of claim 39, wherein at least one operating mode of a motor unit is changed based on a detected characteristic of the moving object.

46. The method of claim 39, wherein an emergency brake mechanism is activated.

47. The machine tool of claim 24, wherein the machine tool is a table saw.

48. The machine tool of claim 24, wherein the machine tool is a circular table saw.
